(19) United States
(12) Patent Application Publication
(10) Pub. No.: US 2025/0309252 A1
(43) Pub. Date: Oct. 2, 2025

(54) POSITIVE ELECTRODE ACTIVE MATERIAL FOR LITHIUM-ION SECONDARY BATTERY, METHOD FOR MANUFACTURING THE SAME, AND LITHIUM-ION SECONDARY BATTERY USING THE SAME

(71) Applicants: HONDA MOTOR CO., LTD., Tokyo (JP); NATIONAL INSTITUTE OF ADVANCED INDUSTRIAL SCIENCE AND TECHNOLOGY, Tokyo (JP)

(72) Inventors: Kazumasa SAKATSUME, Saitama (JP); Takashi HAKARI, Saitama (JP); Kazuki CHIBA, Saitama (JP); Akihisa TANAKA, Saitama (JP); Yoshiyuki MORITA, Saitama (JP); Junji AKIMOTO, Ibaraki (JP); Kunimitsu KATAOKA, Ibaraki (JP); Hideaki NAGAI, Ibaraki (JP)

(21) Appl. No.: 19/084,776

(22) Filed: Mar. 20, 2025

(30) Foreign Application Priority Data
Mar. 30, 2024 (JP) 2024-058344

(51) Int. Cl. H01M 4/505; H01M 4/02; H01M 4/04; H01M 10/0525

(52) U.S. Cl. CPC H01M 4/505; H01M 4/0471; H01M 10/0525; H01M 2004/021; H01M 2004/028

(57) ABSTRACT

A method for manufacturing a positive electrode active material for a lithium-ion secondary battery according to one embodiment of the present invention comprises a step of performing a hydrothermal treatment on a NaMnTi-containing oxide in a lithium aqueous solution, wherein the NaMnTi-containing oxide contains sodium, manganese, and titanium, has a tunnel type structure, and has an average particle diameter in the range of 0.50 μm or more and 3.00 μm or less.

This application is based on and claims the benefit of priority from Japanese Patent Application No. 2024-058344, filed on 30 Mar. 2024, the content of which is incorporated herein by reference.

### BACKGROUND OF THE INVENTION

### Field of the Invention

The present invention relates to a positive electrode active material for a lithium-ion secondary battery, a method for manufacturing the positive electrode active material, and a lithium-ion secondary battery using the positive electrode active material.

### Related Art

In recent years, research and development has been conducted on secondary batteries that contribute to energy efficiency to ensure that more people have access to affordable, reliable, sustainable and advanced energy. As a positive electrode active material for lithium-ion secondary batteries, a LiMnTi-containing oxide that is an oxide containing lithium, manganese and titanium, and has a rock salt type structure is known (Patent Documents 1 to 3).
Patent Document 1: Japanese Unexamined Patent Application, Publication No. 2012-96974
Patent Document 2: PCT International Publication No. WO2017/122663
Patent Document 3: PCT International Publication No. WO2019/087717

### SUMMARY OF THE INVENTION

By the way, in the technology related to secondary batteries, the problems are improvement of electric capacity and sustainability of resources. LiMnTi-containing oxides with a rock salt structure do not contain rare metals used as raw materials for the manufacture of positive electrode active materials such as cobalt and nickel, and have attracted attention from the perspective of resource sustainability. Therefore, it is desirable to further improve the electric capacity of the LiMnTi-containing oxide of the rock salt type structure.

The present invention has been made in view of the above problems, and aims to provide a positive electrode active material for a lithium-ion secondary battery with high electric capacity and high resource sustainability, a method for manufacturing the positive electrode active material, and a lithium-ion secondary battery using the positive electrode active material.

The present inventors have found that it is possible to obtain a fine NaMnTi-containing oxide having a rock salt type structure by hydrothermal treatment of a fine NaMnTi-containing oxide having a tunnel structure in a lithium aqueous solution. Then, it was confirmed that the fine LiMnTi-containing oxide with the rock salt type structure has a high discharge capacity, which led to the completion of the present invention. Therefore, the present invention provides the following.

(1) A positive electrode active material for a lithium-ion secondary battery, comprising an oxide containing lithium, manganese, and titanium, wherein: when a total content ratio of lithium, manganese, and titanium is set to 100 mol %, a content ratio of lithium is in the range of 51 to 56 mol %, a content ratio of manganese is in the range of 22 to 39 mol %, and a content ratio of titanium is in the range of 10 to 23 mol %; a content ratio of sodium is 0.12 mol % or less; the oxide has a rock salt type structure; and an average particle diameter of the oxide is in a range of 0.55 μm or more and 1.65 μm or less.

According to the positive electrode active material for a lithium-ion secondary battery of (1), since the contents of lithium, manganese, and titanium are within the above ranges and the average particle diameter is within the above range, a high electric capacity is achieved while using a material with high resource sustainability.

(2) The positive electrode active material for a lithium-ion secondary battery according to (1), wherein a lattice constant of an a-axis is in the range of 4.1030 Å or more and 4.1210 Å or less.

According to the positive electrode active material for a lithium-ion secondary battery of (2), since the average particle diameter is within the above range and the lattice constant of the a-axis is within the above range, the content of a fine rock salt structure is large, so that a higher electric capacity can be achieved.

(3) The positive electrode active material for a lithium-ion secondary battery according to (1) or (2), wherein, in an X-ray diffraction pattern measured using CuKα as an X-ray source, a diffraction peak present in a diffraction angle 20 range of 43 degrees or more and 45 degrees or less has a full width at half maximum in the range of 0.360 degrees or more and 0.530 degrees or less.

According to the positive electrode active material for a lithium-ion secondary battery of (3), the full width at half maximum is within the above range, and the crystallinity of the rock salt structure that is the main phase is further increased, so that an electric capacity is further increased.

The positive electrode active material for a lithium-ion secondary battery according to any one of (1) to (3), wherein the content ratio of titanium is in the range of 15 mol % to 20 mol %.

According to the positive electrode active material for a lithium-ion secondary battery of (4), the amount of Mn and that of Ti are well balanced, which further increases an electric capacity.

(5) A method for manufacturing a positive electrode active material for a lithium-ion secondary battery, the method comprising a step of performing a hydrothermal treatment on a NaMnTi-containing oxide in a lithium aqueous solution, wherein the NaMnTi-containing oxide contains sodium, manganese, and titanium, has a tunnel type structure, and has an average particle diameter in a range of 0.50 μm or more and 3.00 μm or less.

According to the method for manufacturing the positive electrode active material for a lithium-ion secondary battery of (5), since the average particle diameter of the NaMnTi-containing oxide is within the above range, resulting in smaller particle diameter and larger specific surface area, ion exchange between sodium and lithium during the hydrothermal treatment is facilitated. As a result, a change in the crystal structure is more likely to occur. For this reason, according to the method for manufacturing the positive electrode active material for a lithium-ion secondary battery of (5), a positive electrode active material for a lithium-ion secondary battery having a fine rock salt structure of the main phase and having a high electric capacity can be industrially advantageously manufactured.

(6) The method for manufacturing the positive electrode active material for a lithium-ion secondary battery according to (5), wherein in an X-ray diffraction pattern measured using CuKα as an X-ray source, the NaMnTi-containing oxide has a diffraction peak the diffraction peak having with a full width at half maximum in a range of 0.110 degrees or more and 0.190 degrees or less, in a diffraction angle 20 range of 62 degrees or more and 63 degrees or less.

According to the manufacturing method of (6), since in the NaMnTi-containing oxide, the diffraction peak has a large full width at half maximum and a small particle size, ion exchange between sodium and lithium and a change in the crystal structure are more likely to occur during hydrothermal treatment.

(7) A lithium-ion secondary battery comprising a positive electrode material mixture layer including the positive electrode active material for a lithium-ion secondary battery according to any one of (1) to (4).

According to the lithium-ion secondary battery of (7), since it contains the positive electrode active material for a lithium-ion secondary battery described above, a high electric capacity is achieved while using a material with high resource sustainability.

According to the present invention, it is possible to provide a positive electrode active material for lithium-ion secondary batteries having a high electric capacity and a high resource sustainability, a method for manufacturing the positive electrode active material, and lithium-ion secondary batteries using the positive electrode active material.

### BRIEF DESCRIPTION OF THE DRAWINGS

FIG. 1 is a flow diagram showing a method for manufacturing a positive electrode active material for lithium-ion secondary batteries according to one embodiment of the present invention;

FIG. 2 is an X-ray diffraction pattern of the NaMnTi-containing oxide powder prepared in Examples 1 to 6, subjected to pulverization treatment;

FIG. 3 is an X-ray diffraction pattern of the NaMnTi-containing oxide powder prepared in Comparative Examples 1 to 6, not subjected to pulverization treatment;

FIG. 4 is an X-ray diffraction pattern of LiMnTi-containing oxide powder obtained in Examples 1 to 6;

FIG. 5 is an X-ray diffraction pattern of LiMnTi-containing oxide powder obtained in Comparative Example 1 to 6;

FIG. 6 is an X-ray diffraction pattern of LiMnTi-containing oxide powder obtained in Comparative Example 7;

FIG. 7 is a graph showing the initial charge-discharge curve of a two-electrode cell using the LiMnTi-containing oxide powder obtained in Example 1;

FIG. 8 is a graph showing the initial charge-discharge curve of a two-electrode cell using the LiMnTi-containing oxide powder obtained in Example 2;

FIG. 9 is a graph showing the initial charge-discharge curve of a two-electrode cell using the LiMnTi-containing oxide powder obtained in Example 3;

FIG. 10 is a graph showing the initial charge-discharge curve of a two-electrode cell using the LiMnTi-containing oxide powder obtained in Example 4;

FIG. 11 is a graph showing the initial charge-discharge curve of a two-electrode cell using the LiMnTi-containing oxide powder obtained in Example 5;

FIG. 12 is a graph showing the initial charge-discharge curve of a two-electrode cell using the LiMnTi-containing oxide powder obtained in Example 6;

FIG. 13 is a graph showing the initial charge-discharge curve of a two-electrode cell using the LiMnTi-containing oxide powder obtained in Comparative Example 1;

FIG. 14 is a graph showing the initial charge-discharge curve of a two-electrode cell using the LiMnTi-containing oxide powder obtained in Comparative Example 2;

FIG. 15 is a graph showing the initial charge-discharge curve of a two-electrode cell using the LiMnTi-containing oxide powder obtained in Comparative Example 3;

FIG. 16 is a graph showing the initial charge-discharge curve of a two-electrode cell using the LiMnTi-containing oxide powder obtained in Comparative Example 4;

FIG. 17 is a graph showing the initial charge-discharge curve of a two-electrode cell using the LiMnTi-containing oxide powder obtained in Comparative Example 5;

FIG. 18 is a graph showing the initial charge-discharge curve of a two-electrode cell using the LiMnTi-containing oxide powder obtained in Comparative Example 6; and FIG. 19 is a graph showing the initial charge-discharge curve of a two-electrode cell using the LiMnTi-containing oxide powder obtained in Comparative Example 7.

### DETAILED DESCRIPTION OF THE INVENTION

Hereinafter, embodiments of the present invention will be described. However, the following embodiments illustrate the present invention, and the present invention is not limited to the following embodiments.

The positive electrode active material for the secondary batteries of the present embodiment includes LiMnTi-containing oxide containing a lithium (Li), manganese (Mn), and titanium (Ti). The positive electrode active material for the secondary batteries may include only the LiMnTi-containing oxide.

The LiMnTi-containing oxide has a content ratio of Li in the range of 51 to 56 mol %, a content ratio of Mn in the range of 22 to 39 mol %, a content ratio of Ti in the range of 10 to 23 mol%, and a content ratio of Na of 0.12 mol % or less when the total content of Li, Mn, and Ti is 100 mol %. The content ratio of Ti may be in the range of 15 to 20 mol %. When the content ratio is within this range, the amount of Mn and Ti is better balanced, so an electric capacity is better.

The LiMnTi-containing oxide is represented by the following general formula (I).

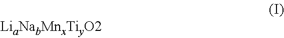

However, in the above general formula (I), a+x+y is 2, a satisfies a relationship of 1.02≤a≤1.12, b satisfies a relationship of 0≤b≤0.0024, x satisfies a relationship of 0.44≤x≤0.78, y satisfies a relationship of 0.20≤y≤ 0.46. y may satisfy a relationship of 0.30≤y≤0.40.

The LiMnTi-containing oxide has a rock salt type structure. It may have a single phase of a rock salt type structure of a LiMnTi-containing oxide. The lattice constant of an a-axis of the LiMnTi-containing oxide may be in the range of 4.1030 Å or more and 4.1210 Å or less. If the average particle diameter is within the above range and the lattice constant of the a-axis is within this range, an electric capacity is higher because the content of the fine rock salt structure is higher. In an X-ray diffraction pattern of the LiMnTi-containing oxide measured using CuKα as an X-ray source, a peak in a diffraction angle 20 range of 43 degrees or more and 45 degrees or less may have a full width at half maximum (FWHM) in a range of 0.360 degrees or more and 0.530 degrees or less. The LiMnTi-containing oxide with this diffraction peak within this range has a higher crystallinity of the rock salt structure as the main phase, resulting in a higher electric capacity.

The LiMnTi-containing oxide has an average particle diameter in the range of 0.55 μm or more and 1.65 μm or less. The average particle diameter can be measured by laser diffraction scattering method. The particle shape of the LiMnTi-containing oxide may be, for example, spherical, cylindrical, or amorphous, without particular limitation.

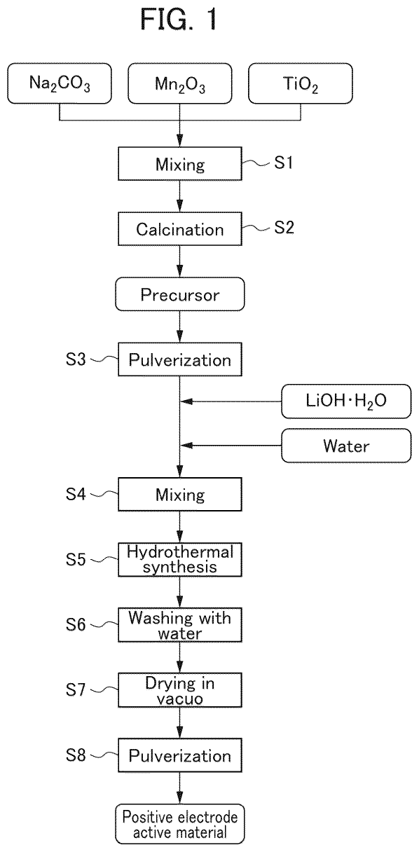

The positive electrode active material for lithium-ion secondary batteries of the present embodiment can be manufactured by a method comprising a step of obtaining a precursor of a LiMnTi-containing oxide and a step of producing a LiMnTi-containing oxide from the obtained precursor. The precursor is a NaMnTi-containing oxide including sodium, manganese and titanium. As a method for producing the LiMnTi-containing oxide from the NaMnTi-containing oxide, a method can be used in which the NaMnTi-containing oxide is subjected to hydrothermal treatment in a lithium aqueous solution to replace sodium with lithium. The method for manufacturing the positive electrode active material for lithium-ion secondary batteries according to the present embodiment will be described with reference to FIG. 1.

The step of obtaining the NaMnTi-containing oxide (precursor) includes a mixing step S1, a calcinating step S2, and a pulverization step S3, as shown in FIG. 1.

In the mixing step S1, a sodium source, a manganese source and a titanium source are mixed to obtain a raw material mixture. The sodium source, manganese source, and titanium source are not particularly limited, and various compound such as oxide, carbonate, hydroxide, and chloride can be used. In this embodiment, Na₂CO₃ is used as the sodium source, Mn₂O₃ is used as the manganese source, and TiO₂ is used as the titanium source.

The mixing ratio of the sodium source, manganese source, and titanium source is, for example, a ratio in which the amount of sodium is 0.44 mol when the total amount of manganese and titanium is set to 1 mol. The mixing ratio of the manganese source and the titanium source is a ratio in which the amount of manganese is, for example, 0.50 mol or more and 0.80 mol or less when the total amount of manganese and titanium is set to 1 mol. The mixing method of the sodium source, manganese source and titanium source is not particularly limited and may be performed in a dry manner or may be performed in a wet manner.

In the calcinating step S2, the raw material mixture obtained in the mixing step S1 is calcined to produce a NaMnTi-containing oxide having a tunnel type structure. The calcinating condition of the raw material mixture can be, for example, 900 to 1200° C. in the atmosphere. The calcinating time varies depending on conditions such as the composition or the raw material mixture and calcinating temperature, but is in the range of, for example, 1 to 30 hours.

In the pulverization step S3, the NaMnTi-containing oxide obtained in the calcinating step S2 is pulverized to be become a fine powder. The pulverization may be carried out in a dry manner or in a wet manner. The pulverizing method is not particular limited, and various pulverization apparatus that are used as pulverizing methods for inorganic materials such as ball mill, bead mill, jet mill, mortar and pestle can be used for pulverizing. The average particle diameter of the NaMnTi-containing oxide after pulverizing is in the range of 0.50 μm or more and 3.00 μm or less.

The NaMnTi-containing oxide obtained as described above is represented, for example, by the following general formula (II).

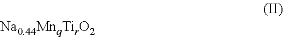

However, in general formula (II) above, q and r satisfy q+r=1. q may satisfy 0.50≤q≤0.80, for example.

In an X-ray diffraction pattern measured using CuKα as an X-ray source, the NaMnTi-containing oxide may have a diffraction peak with a full width at half maximum (FWHM) in a range of 0.110 degrees or more and 0.190 degrees less, in a diffraction angle 20 range of 62 degrees or more and 63 degrees or less. Since the full width at half maximum (FWHM) of this diffraction peak is within this range, and the size of the particles is small, ion exchange between sodium and lithium is more likely to occur during hydrothermal treatment.

The step of producing the LiMnTi-containing oxide from the NaMnTi-containing oxide includes a mixing step S4, a hydrothermal synthesis step S5, a water washing step S6, a drying step S7, and a pulverization step S8, as shown in FIG. 1.

In the mixing step S4, the NaMnTi-containing oxide, a lithium source, and water are mixed to obtain a dispersion liquid in which a NaMnTi-containing oxide is dispersed in a lithium aqueous solution. There is no particular limitation as the lithium source, and various compounds such as oxide, carbonate, hydroxide, and chloride can be used. In the present embodiment, LiOH·H₂O is used as the lithium source. The lithium content in the dispersion liquid is in the range of 2.0 to 30.0 mol, for example, when the total molar amount of the manganese and the titanium contained in the NaMnTi-containing oxide in the dispersion liquid is set to 1 mol.

In the hydrothermal synthesis step S5, the NaMnTi-containing oxide in the dispersion liquid obtained in the mixing step S4 is hydrothermally treated to hydrothermally synthesize the LiMnTi-containing oxide. By hydrothermally treating the NaMnTi-containing oxide in a lithium aqueous solution, the sodium of the NaMnTi-containing oxide is replaced with lithium, and the crystal structure of the NaMnTi-containing oxide is changed to produce a LiMnTi-containing oxide with a rock salt type structure. Hydrothermal treatment can be performed, for example, by accommodating the dispersion liquid in a sealed container and heating the sealed container in air at a temperature of 150 to 230° C. The treatment time of hydrothermal treatment depends on conditions such as the ratio of NaMnTi-containing oxide and lithium source in the dispersion liquid and the capacity of the sealed container, but for example, in the range of 1 to 30 hours.

In the water washing step S6, the LiMnTi-containing oxide produced in the hydrothermal synthesis step S5 is recovered and washed with water. By washing the LiMnTi-containing oxide with water, sodium replaced with lithium and unreacted lithium source are removed.

In the drying step S7, the LiMnTi-containing oxide washed with water in the water washing step S6 is dried. The drying method is not particularly limited, and various methods used as drying methods for inorganic material such as heat drying method, vacuum drying method, and spray drying method can be used.

In the pulverization step S8, the LiMnTi-containing oxide dried in the drying step S7 is pulverized and adjusted to a particle size that can be used as a positive electrode active material for secondary batteries. The pulverization may be carried out in a dry manner or in a wet manner. The pulverizing method is not particular limited, and various pulverization apparatus that are used as pulverizing methods for inorganic materials such as ball mill, bead mill, jet mill, mortar and pestle can be used for pulverizing.

The positive electrode active material for lithium-ion secondary batteries of the present embodiment can be used as a positive electrode active material of lithium-ion secondary batteries. A lithium-ion secondary battery has, for example, a positive electrode, a negative electrode, an electrolyte solution, a separator arranged between the positive electrode and the negative electrode, and an outer casing that accommodates these. A solid electrolyte may be used instead of the electrolyte solution.

The positive electrode includes a positive electrode current collector and a positive electrode active material layer formed on the surface of the positive electrode current collector. The positive electrode active material layer includes the positive electrode active material for the lithium-ion secondary batteries of the present embodiment. The positive electrode active material layer may include a conductive additive and a binder. Since the positive electrode active material for the secondary batteries of the present embodiment is chemically stable, the conductive additive and the binder are not particularly limited, and a known one used in the positive electrode active material layer of lithium-ion secondary batteries can be used. Further, the positive electrode current collector is not particularly limited, and a known one used in the positive electrode current collector of lithium-ion secondary batteries such as an aluminum foil can be used.

As the negative electrode, a laminated body including a negative electrode current collector and a negative electrode active material layer formed on the surface of the negative electrode current collector can be used. The negative electrode active material layer includes a negative electrode active material. As the negative electrode active material, lithium metal, a material capable of absorbing and releasing lithium, a metal or a metalloid forming an alloy with lithium can be used. Examples of materials capable of absorbing and releasing lithium include lithium transition metal oxide such as lithium titanate, transition metal oxide such as TiO₂, Nb₂O₃, and WO₃, SiO, metal sulfide, metal nitride, and carbon materials such as artificial graphite, natural graphite, graphite, soft carbon, and hard carbon. Examples of metals or metalloids that form an alloy with lithium include Mg, Si, Au, Ag, In, Ge, Sn, Pb, Al, and Zn, etc. When the negative electrode active material is in powder form, the negative electrode active material layer may include a conductive additive and a binder. The conductive additive and the binder are not particularly limited, and a known one used in the negative electrode active material layer of lithium-ion secondary batteries can be used. Further, the negative electrode current collector is not particularly limited, and a known material used in the negative electrode current collector of lithium-ion secondary batteries such as a copper foil can be used.

An electrolyte solution includes an organic solvent and an electrolyte. As the organic solvent, for example, cyclic carbonate, chain carbonate, cyclic ether, chain ether, hydrofluoroether, aromatic ether, sulfone, cyclic ester, chain carboxylic acid ester, and nitrile can be used. Examples of cyclic carbonates include ethylene carbonate, propylene carbonate, vinylene carbonate, and fluoroethylene carbonate, etc. Examples of chain carbonates include dimethyl carbonate, diethyl carbonate, and ethyl methyl carbonate, etc. Examples of cyclic ethers include tetrahydrofuran, 2-methyltetrahydrofuran, tetrahydropyran, 1,3-dioxolane, and 4-methyl-1,3-dioxolane, etc. Examples of chain ethers include 1,2-dimethoxyethane, 1,2-diethoxyethane, ethoxymethoxyethane, and diethyl ether, etc. Examples of hydrofluoroethers include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, and 1,2-bis(1,1,2,2-tetrafluoroethoxy) ethane, etc. Example of aromatic ether includes anisole. Examples of sulfones include sulfolane and methyl sulfolane, etc. Examples of cyclic esters include γ-butyrolactone, etc. Examples of chain carboxylic acid esters include acetate esters, butyrate esters, and propionate esters, etc. Examples of nitriles include acetonitrile and propionitrile, etc. As for the organic solvents, one type may be used either alone or in combination with two or more.

The electrolyte is a source of lithium ions, which are charge transfer mediums and include lithium salts. Examples of lithium salts include LiPF₆, LiBF₄, LiClO₄, LiAsF₆, LiCF₃SO_{3,} LiC(CF₃SO₂)₃, LiN(CF₃SO₂)₂ (LiTFSI), LiN(FSO₂)₂ (LiFSI), and LiBC₄O₈, etc. As for the lithium salt, one type may be used either alone or in combination with two or more.

As the solid electrolyte, for example, a sulfide solid electrolyte, an oxide solid electrolyte, a nitride solid electrolyte, a halide solid electrolyte, and the like can be used. Examples of sulfide solid electrolytes include Li₂S—P₂Ss, Li₂S—P₂Ss—LiI, etc. Examples of the oxide solid electrolyte include NASICON type oxide, garnet type oxide, perovskite type oxide, etc. Examples of NASICON type oxides include oxides containing Li, Al, Ti, P, and 0 (e.g., Li_{1.5}Al_{0.5}Ti_{1.5} (PO₄)₃). Examples of garnet type oxides include oxides containing Li, La, Zr, and O (e.g., Li₂La₃Zr₂O₁₂). Examples of perovskite type oxides include oxides containing Li, La, Ti, and O (e.g., LiLaTiO₃).

The separator is not particularly limited, for example, a porous sheet or a nonwoven fabric sheet can be used. Examples of materials for the porous sheet include polyolefins such as polyethylene and polypropylene, aramid, polyimide, and fluorine resins, etc. Examples of materials for the nonwoven fabric sheet include fiberglass, cellulose fibers, etc.

The outer casing is not particularly limited, and a known outer casing used in lithium-ion secondary batteries, such as metal container or laminated film container, and the like can be used.

According to the positive electrode active material for lithium-ion secondary batteries of the present embodiment with the configuration as described above, since the contents of lithium, manganese, and titanium are within the above ranges and the average particle diameter is within the above range, a high reactivity can be achieved while using a material with high resource sustainability.

According to the method for manufacturing the positive electrode active material for lithium-ion secondary batteries of the present embodiment, since the average particle diameter of the NaMnTi-containing oxide is within the above range, resulting in smaller particle diameter and larger specific surface area, ion exchange between sodium and lithium during the hydrothermal treatment is facilitated. As a result, a change in the crystal structure is more likely to occur. For this reason, according to the method for manufacturing the positive electrode active material for lithium-ion secondary batteries of the present embodiment, a positive electrode active material for lithium-ion secondary batteries having a fine and containing a high amount of rock salt structure and having a high electric capacity can be industrially advantageously manufactured.

According to the lithium-ion secondary battery of the present embodiment, since it contains the positive electrode active material for lithium-ion secondary batteries described above, an electric capacity is high while using a material with a high resource sustainability.

### EXAMPLES

### Example 1

### Preparation of NaMnTi-containing oxide powder

Na₂CO₃, Mn₂O₃, and TiO₂ were weighed in such quantities so that the molar ratio of Na, Mn, and Ti was 0.440:0.500:0.500, with a total mass of 3.0 g. The weighed Na₂CO₃, Mn₂O₃, and TiO₂ were mixed with a mortar and pestle. The resulting raw material mixture was placed in an alumina crucible and calcined under atmospheric conditions at a calcinating temperature of 1000° C. for 12 hours. The obtained calcined product 2 g was placed into a 45 mL zirconia ball mill container, 60 g of zirconia balls (diameter: 5 mm) and 15 mL of ethanol were added to the ball mill container, and then pulverize treatment was performed at 350 rpm for 12 hours. After pulverization, the powder was recovered and dried in vacuo at 60° C. for 12 hours. The pulverization treatment using ball mills was performed a total of 3 times. From the X-ray diffraction pattern of the pulverized calcined product, it was confirmed that the obtained calcined product was a NaMnTi-containing oxide powder having a tunnel structure.

### Preparation of LiMnTi-containing oxide powder

2.00 g of LiOH·H₂O and 50 mL of water were placed in a hydrothermal reaction vessel and stirred to dissolve the LiOH·H₂O, resulting in the preparation of a LiOH solution. Then, 0.5 g of NaMnTi oxide powder obtained above was added to the LiOH solution and stirred to obtain a dispersion liquid of the NaMnTi oxide powder dispersed in the LiOH solution. The hydrothermal reaction vessel was then sealed and the sealed hydrothermal reaction vessel was placed in a thermostatic bath and heated in the atmosphere at a heating temperature of 180° C. for 24 hours to hydrothermally treat the NaMnTi oxide powder. After heating, hydrothermal treated powder (LiMnTi-containing oxide powder) was recovered from the hydrothermal reaction vessel. After washing the recovered LiMnTi-containing oxide powder with water, three operations were performed to remove moisture by centrifugation. The moisture removed LiMnTi-containing oxide powder was placed on a petri dish and dried in vacuo at a temperature of 100° C. for 6 hours. After drying, the LiMnTi-containing oxide powder was pulverized using mortar and pestle.

### Examples 2 to 6

LiMnTi-containing oxide powders were prepared in the same manner as in Example 1 except that the blending amount of Na₂CO₃, Mn₂O₃, and TiO₂ was taken as the amount shown in Table 1 below.

### Comparative Example 1

In the preparation of the NaMnTi-containing oxide powder, the LiMnTi-containing oxide powder was prepared in the same manner as in Example 1, except that no pulverization treatment with a ball mill was performed.

### Comparative Example 2

In the preparation of the NaMnTi-containing oxide powder, the LiMnTi-containing oxide powder was prepared in the same manner as in Example 2, except that no pulverization treatment with a ball mill was performed.

### Comparative Example 3

In the preparation of the NaMnTi-containing oxide powder, the LiMnTi-containing oxide powder was prepared in the same manner as in Example 3, except that no pulverization treatment with a ball mill was performed.

### Comparative Example 4

In the preparation of the NaMnTi-containing oxide powder, the LiMnTi-containing oxide powder was prepared in the same manner as in Example 4, except that no pulverization treatment with a ball mill was performed.

### Comparative Example 5

In the preparation of the NaMnTi-containing oxide powder, the LiMnTi-containing oxide powder was prepared in the same manner as in Example 5, except that no pulverization treatment with a ball mill was performed.

### Comparative Example 6

In the preparation of the NaMnTi-containing oxide powder, the LiMnTi-containing oxide powder was prepared in the same manner as in Example 6, except that no pulverization treatment with a ball mill was performed.

### Comparative Example 7

LiMnTi-containing oxide powder was prepared by the following method.

### Preparation of Li₂TiO₃ Powder

Li₂CO₃ and TiO₂ were weighed in such quantities so that the molar ratio of Li and Ti was 2.00:1.00, with a total mass of 2.0 g. Li₂CO₃ and TiO₂ weighed were mixed with a mortar and pestle. The resulting raw material mixture was placed in an alumina crucible and calcined under atmospheric conditions at a calcinating temperature of 950° C. for 12 hours. The resulting calcined product was pulverized with a mortar and pestle to prepare Li₂TiO₃ powder.

### Preparation of LiMnO₂ Powder

Li₂CO₃ and Mn₂O₃ were weighed in such quantities so that the molar ratio of Li and Mn was 1.00:1.00, with a total mass of 2.0 g. Li₂CO₃ and Mn₂O₃ weighed were mixed with a mortar and pestle. The resulting raw material mixture was placed in an alumina crucible and calcined under argon gas conditions at a calcinating temperature of 800° C. for 12 hours. The resulting calcined product was pulverized with a mortar and pestle to prepare LiMnO₂ powder.

### Preparation of LiMnTi-Containing Oxide Powder

The obtained Li₂TiO₃ powder 0.66 g and LiMnO₂ powder 0.85 g were placed into a 45 mL zirconia ball mill container, and then 13.5 g of zirconia balls (diameter: 4 mm) and zirconia balls (diameter: 2 mm) were added to the ball mill container, and pulverize treatment was performed at 600 rpm for 12 hours. The resulting pulverized product was further pulverized with a mortar and pestle to prepare LiMnTi-containing oxide powder.

### Evaluation of NaMnTi-Containing Oxide Powder

For the NaMnTi-containing oxide powder prepared in Examples 1 to 6 and Comparative Examples 1 to 6, the average particle diameter, X-ray diffraction pattern, lattice constant, and a full width at half maximum (FWHM) were measured by the following methods.

### (Average Particle Diameter)

Measured using a laser diffusion scattering particle size distribution analyzer. The results are shown in Table 1 below.

### (X-Ray Diffraction Pattern)

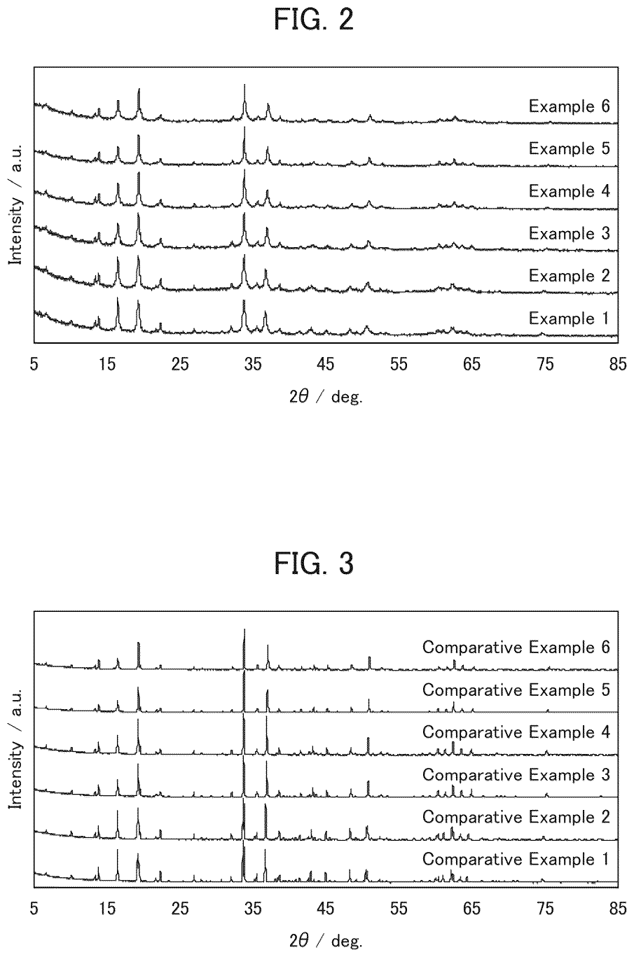

The X-ray diffraction pattern was measured under the following conditions. The X-ray diffraction pattern of the NaMnTi-containing oxide fine powder (pulverization treatment: with) prepared in Examples 1 to 6 is shown in FIG. 2, and the X-ray diffraction pattern of the NaMnTi-containing oxide fine powder (pulverization treatment: without) produced in Comparative Examples 1 to 6 is shown in FIG. 3.
Measurement apparatus: RINT-2550V, manufactured by Rigaku Co., Ltd. X-ray source: CuKα
X-ray output: 40 kV, 200 mA
Measurement conditions: 1.0 s, 0.03 deg interval

### (Lattice Constant)

The lattice constants of a-axis, b-axis and c-axis were measured using the above X-ray diffraction pattern. The lattice constant was determined by the least squares method using each index of the diffraction peak due to the tunnel structure extracted from the X-ray diffraction pattern and its interfacial spacing. The results are shown in Table 2 below.

### (Full Width at Half Maximum (FWHM))

Diffraction peaks with a diffraction angle 20 in the range of 62 degrees or more and 63 degrees or less were extracted from the above X-ray diffraction pattern. A full width at half maximum (FWHM) of the extracted peak was measured. The results are shown in Table 1 below.

TABLE 1

| | | | | | | | | | | | | Full width |
|---|---|---|---|---|---|---|---|---|---|---|---|---|
| | | | | With or | Average | Lattice constant (Å) | | | | | | at half |
| | Raw material blending | | | without | particle | a-axis | | b-axis | | c-axis | | maximum |
| | amount (mol) | | | pulverization | diameter | Average | Error | Average | Error | Average | Error | FWHMz |
| | Na | Mn | Ti | treatment | (μm) | value | bar | value | bar | value | bar | (degrees) |
| Example 1 | 0.440 | 0.500 | 0.500 | with | 0.56 | 9.2297 | 19 | 26.399 | 7 | 2.8855 | 5 | 0.620 |
| Comparative | 0.440 | 0.500 | 0.500 | without | 8.00 | 9.2466 | 7 | 26.446 | 2 | 2.8896 | 2 | 0.111 |
| Example 1 | | | | | | | | | | | | |
| Example 2 | 0.440 | 0.560 | 0.440 | with | 1.24 | 9.2150 | 2 | 26.423 | 6 | 2.8825 | 6 | 0.590 |
| Comparative | 0.440 | 0.560 | 0.440 | without | 4.99 | 9.2291 | 10 | 26.470 | 3 | 2.8830 | 3 | 0.120 |
| Example 2 | | | | | | | | | | | | |
| Example 3 | 0.440 | 0.615 | 0.385 | with | 0.68 | 9.1830 | 2 | 26.409 | 6 | 2.8646 | 6 | 0.480 |
| Comparative | 0.440 | 0.615 | 0.385 | without | 5.17 | 9.2008 | 9 | 26.501 | 3 | 2.8683 | 3 | 0.174 |
| Example 3 | | | | | | | | | | | | |
| Example 4 | 0.440 | 0.670 | 0.330 | with | 0.99 | 9.1801 | 19 | 26.419 | 5 | 2.8661 | 5 | 0.400 |
| Comparative | 0.440 | 0.670 | 0.330 | without | 17.1 | 9.2027 | 9 | 26.505 | 3 | 2.8684 | 3 | 0.188 |
| Example 4 | | | | | | | | | | | | |
| Example 5 | 0.440 | 0.725 | 0.275 | with | 1.07 | 9.1756 | 15 | 26.456 | 4 | 2.8614 | 4 | 0.206 |
| Comparative | 0.440 | 0.725 | 0.275 | without | 4.79 | 9.1876 | 7 | 26.505 | 2 | 2.8620 | 2 | 0.141 |
| Example 5 | | | | | | | | | | | | |
| Example 6 | 0.440 | 0.780 | 0.220 | with | 2.99 | 9.1550 | 2 | 26.418 | 6 | 2.8519 | 5 | 0.500 |
| Comparative | 0.440 | 0.780 | 0.220 | without | 6.77 | 9.1735 | 10 | 26.483 | 3 | 2.8543 | 3 | 0.167 |
| Example 6 | | | | | | | | | | | | |

From the X-ray diffraction pattern in FIGS. 2 to 3 and the results in Table 1, it can be seen that the NaMnTi-containing oxide powder of Examples 1 to 6, which subjected to the pulverization treatment, has a smaller average particle diameter and, therefore, a larger specific surface area; and broader X-ray diffraction pattern and larger full width at half maximum (FWHM), therefore, smaller size of the crystallite when compared to the NaMnTi-containing oxide powder of Comparative Examples 1 to 6, which did not subject to the pulverization treatment. Thus, the NaMnTi-containing oxide powder of Examples 1 to 6 are prone to ion exchange between sodium and lithium during hydrothermal treatment compared to the NaMnTi-containing oxide powder of Comparative Examples 1 to 6.

### Evaluation LiMnTi-Containing Oxide Powder

For the NaMnTi-containing oxide powder prepared in Examples 1 to 6 and Comparative Examples 1 to 6, the average particle diameter, X-ray diffraction pattern, lattice constant of an a-axis, a full width at half maximum (FWHM), and discharge capacity were measured by the following methods.

### (Chemical Composition)

The sample was dissolved in acid. The content of Li, Na, Mn and Ti in the resulting solution was measured using an ICP luminescence spectrometer. The obtained Li, Na, Mn, and Ti contents were converted into molar content ratios, with the total content of Li, Mn, and Ti set to 100 mol %. The results are shown in Table 2 below.

### (X-Ray Diffraction Pattern)

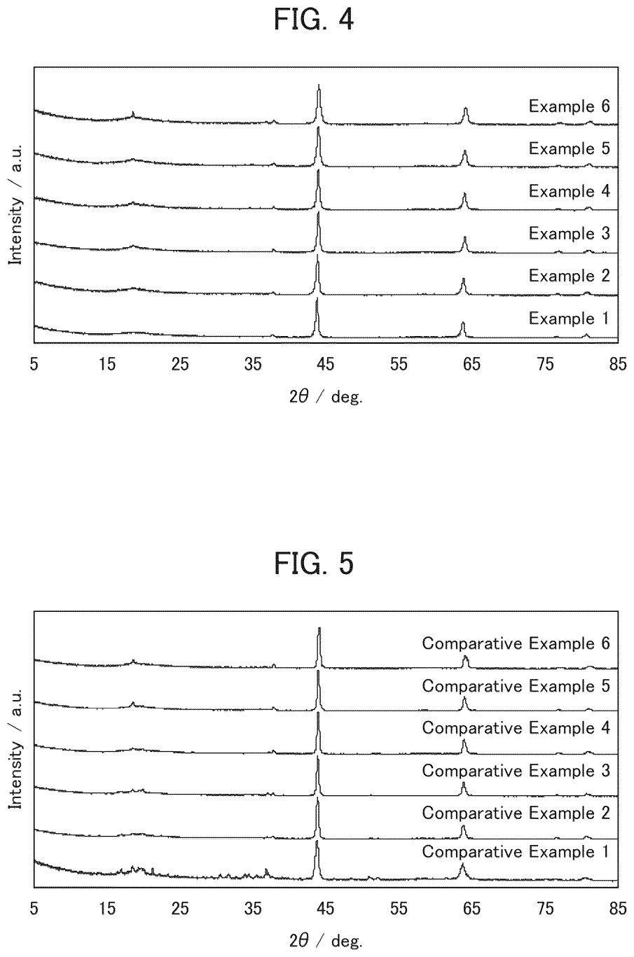

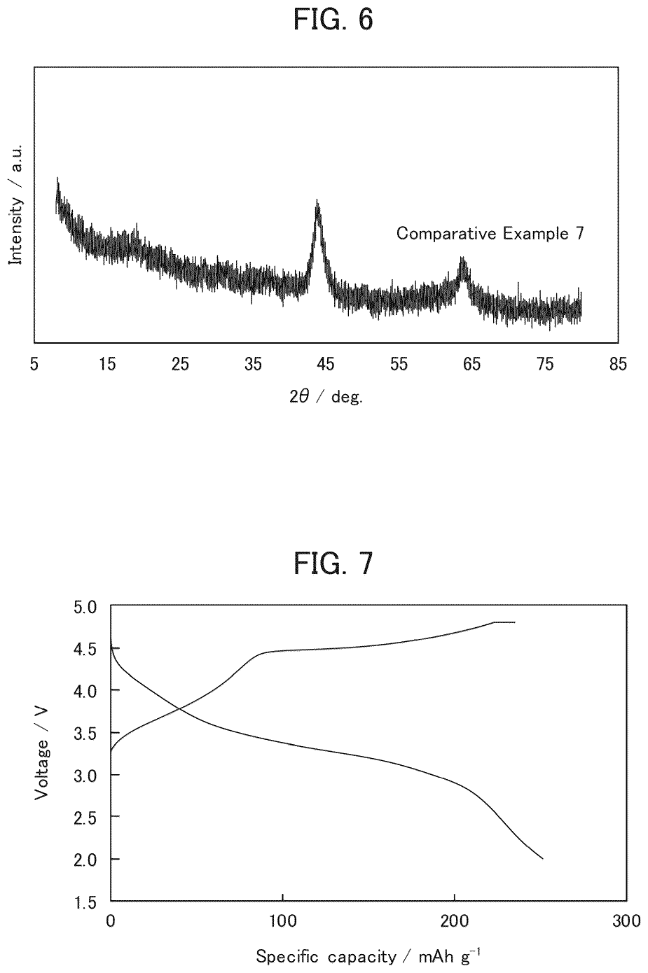

The X-ray diffraction pattern was measured under the same conditions as the X-ray diffraction pattern of the above NaMnTi-containing oxide powder. The X-ray diffraction pattern of the LiMnTi-containing oxide powder obtained in Examples 1 to 6 is shown in FIG. 4, the X-ray diffraction pattern of the LiMnTi-containing oxide powder obtained in Comparative Examples 1 to 6 is shown in FIG. 5, and the X-ray diffraction pattern of the LiMnTi-containing oxide powder obtained in Comparative Example 7 is shown in FIG. 6.

(Lattice Constant of a-axis)

The lattice constant of an a-axis was measured using the above X-ray diffraction pattern. The lattice constant was determined by the least squares method using each index of the diffraction peak due to the tunnel structure extracted from the X-ray diffraction pattern and its interfacial spacing. The results are shown in Table 2 below.

### (Full Width at Half Maximum (FWHM))

Diffraction peaks with a diffraction angle 20 in the range of 43 degrees or more and 45 degrees or less were extracted from the above X-ray diffraction pattern. A full width at half maximum (FWHM) of the extracted peak was measured. The results are shown in Table 3 below.

(Charge-discharge characteristics)

5 mg of sample was mixed with 5 mg of acetylene black as conductive material and 1 mg of PTFE as binder. The resulting mixture was molded into a sheet, crimped onto an Al mesh as a working electrode, and a counter electrode was a lithium metal foil. The working electrode and the counter electrode were immersed in an electrolyte solution in which LiPF₆ was dissolved in an EC+DMC solvent to prepare a two-electrode cell.

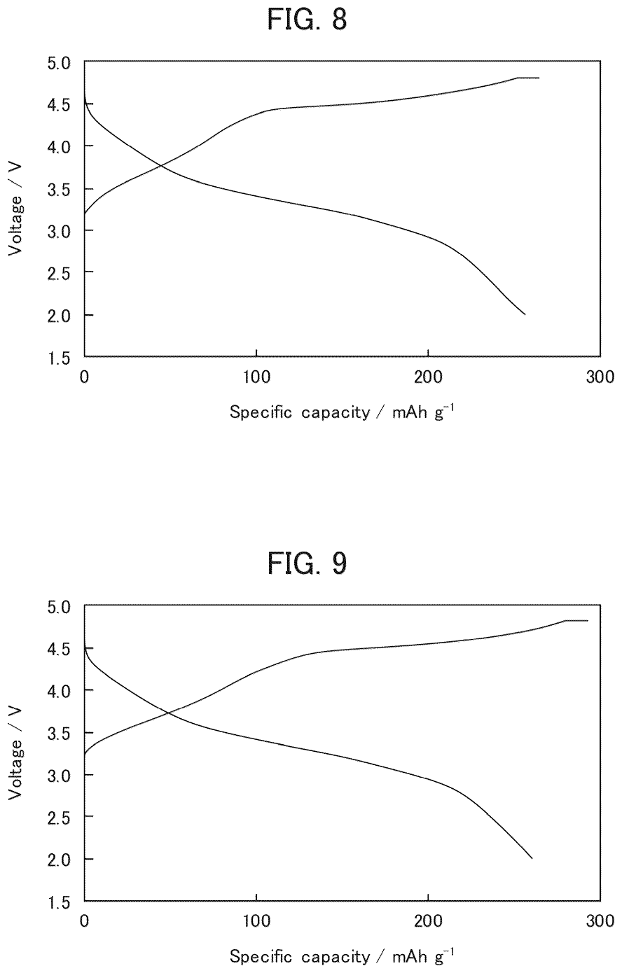

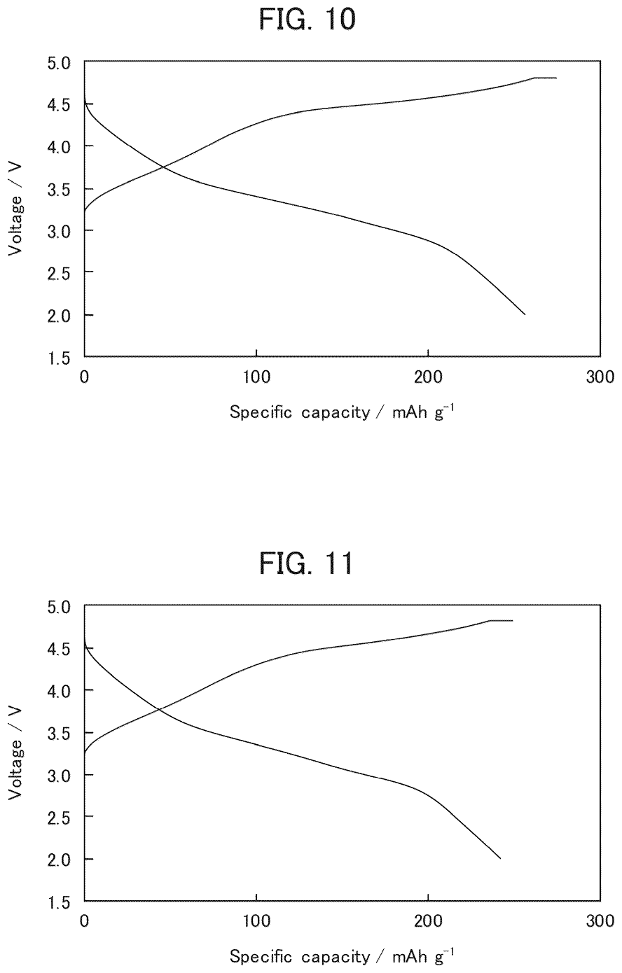

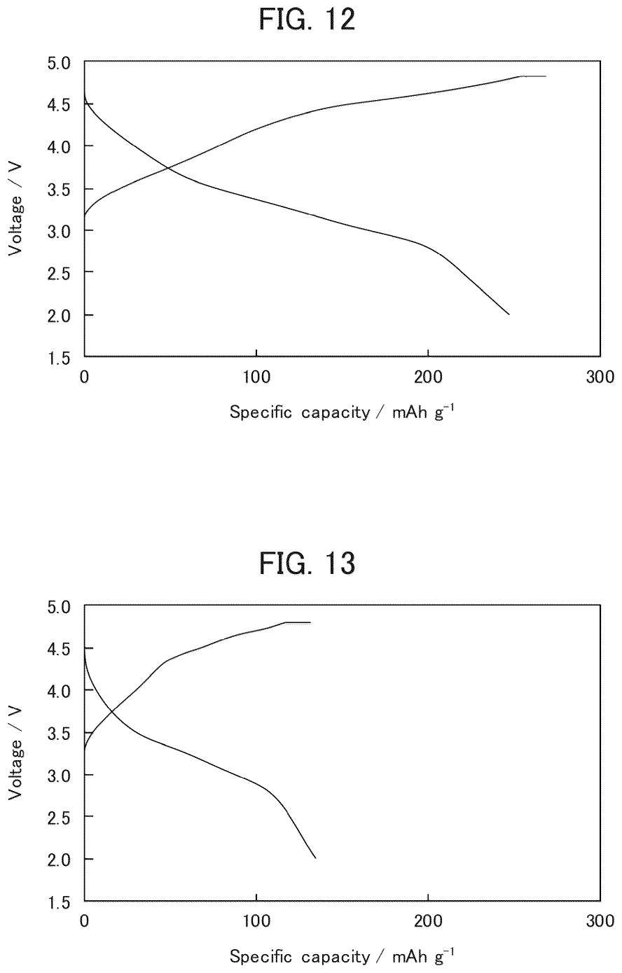

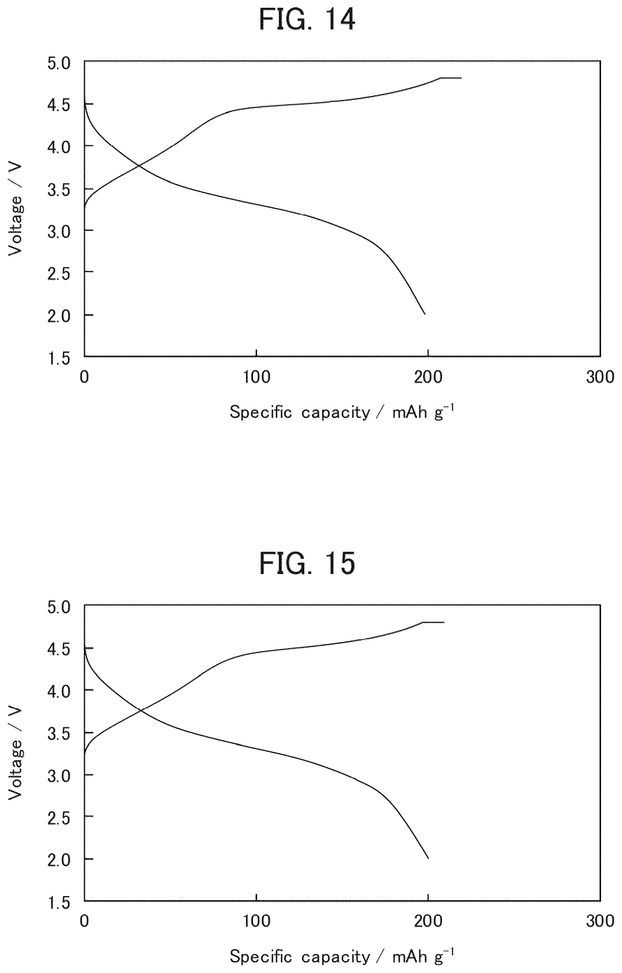

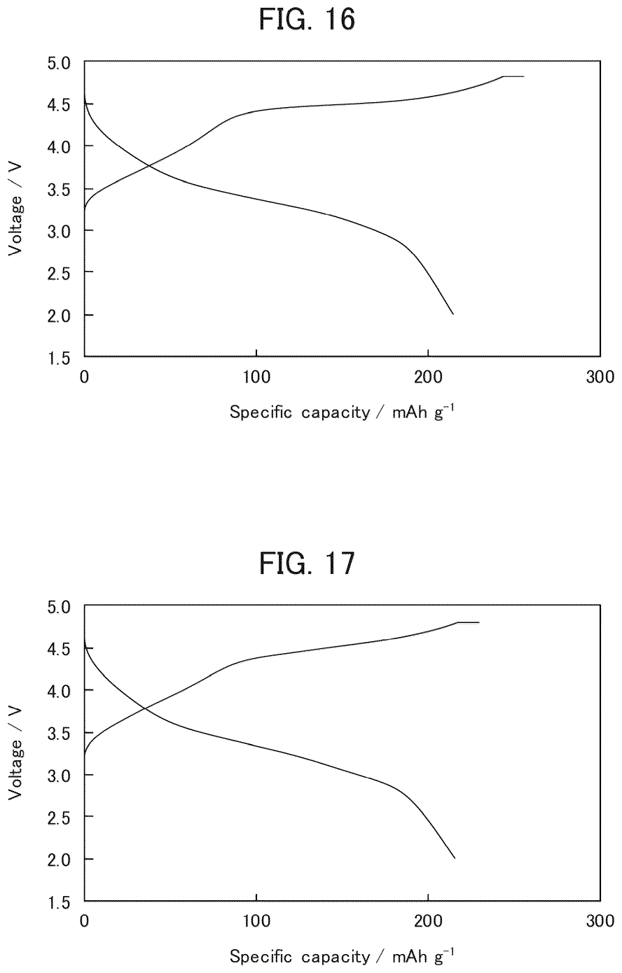

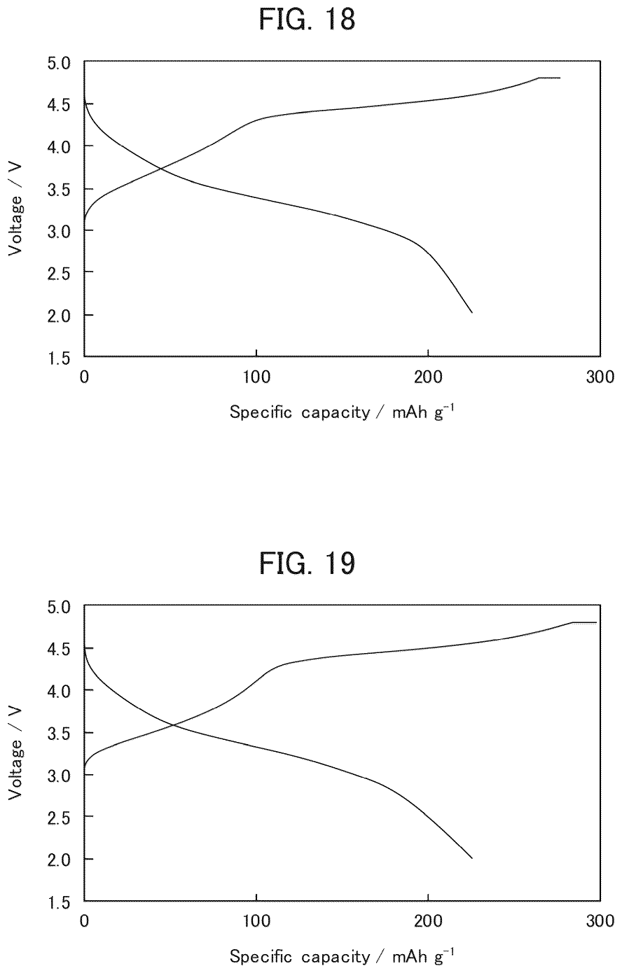

Charge-discharge tests were performed using two-electrode cell. The conditions of the charge-discharge tests were that the current density (per sample) was 10 mA/g, the potential range was 2.0 to 4.8 V, and the charging was constant current-constant voltage charging (until 2 hours have passed). The charge-discharge test was performed under an environment of 25° C. The initial (first cycle) discharge capacity is shown in Table 2 below. Further, the initial charge-discharge curve of the two-electrode cell using the LiMnTi-containing oxide powder obtained in Examples 1 to 6 is shown in FIGS. 7 to 12, and the initial charge-discharge curve of the two-electrode cell using the LiMnTi-containing oxide powder obtained in Comparative Examples 1 to 7 is shown in FIGS. 13 to 19.

TABLE 2

| | | | | | | | | | Full | |
|---|---|---|---|---|---|---|---|---|---|---|
| | | | | | | Average | Lattice constant of | | width | |
| | With or | | | | | particle | a-axis (Å) | | at half | Discharge |
| | without | Chemical composition (mol %) | | | | diameter | Average | Error | maximum | capacity |
| | pulverization | Li | Na | Mn | Ti | (μm) | value | bar | FWHM | (mAh/g) |
| Example 1 | with | 55.0 | 0.115 | 22.5 | 22.5 | 1.61 | 4.1207 | 4 | 0.3680 | 250 |
| Comparative | without | 54.9 | 2.513 | 23.1 | 22.1 | 19.39 | 4.1259 | 8 | 0.5340 | 135 |
| Example 1 | | | | | | | | | | |
| Example 2 | with | 54.5 | 0.070 | 26.0 | 19.5 | 1.04 | 4.1165 | 5 | 0.3890 | 260 |
| Comparative | without | 57.6 | 0.556 | 23.7 | 18.7 | 4.91 | 4.1281 | 2 | 0.3690 | 198 |
| Example 2 | | | | | | | | | | |
| Example 3 | with | 55.0 | 0.023 | 28.5 | 16.5 | 0.7 | 4.1088 | 5 | 0.3730 | 260 |
| Comparative | without | unmeasured | | | | 0.69 | 4.1282 | 3 | 0.3270 | 200 |
| Example 3 | | | | | | | | | | |
| Example 4 | with | 55.3 | 0.116 | 30.7 | 14.1 | 0.61 | 4.1110 | 14 | 0.3980 | 255 |
| Comparative | without | 56.8 | 0.477 | 29.1 | 14.1 | 10.96 | 4.1150 | 2 | 0.3583 | 214 |
| Example 4 | | | | | | | | | | |
| Example 5 | with | 51.7 | 0.075 | 37.8 | 10.4 | 0.79 | 4.1084 | 5 | 0.4710 | 245 |
| Comparative | without | unmeasured | | | | 2.6 | 4.1195 | 14 | 0.3470 | 216 |
| Example 5 | | | | | | | | | | |
| Example 6 | with | 51.5 | 0.01 or less | 38.0 | 10.5 | 0.59 | 4.1037 | 6 | 0.5240 | 250 |
| Comparative | without | 57.5 | 0.085 | 33.0 | 9.5 | 0.79 | 4.1099 | 4 | 0.3820 | 226 |
| Example 6 | | | | | | | | | | |
| Comparative | — | 58.5 | 0.01 or less | 25.0 | 16.5 | 0.65 | 4.1490 | 2 | 2.2500 | 226 |
| Example 7 | | | | | | | | | | |

From the X-ray diffraction pattern of FIGS. 4 to 7, it was confirmed that the LiMnTi-containing oxide powder obtained in Examples 1 to 6 and Comparative Examples 1 to 6 had a rock salt type structure as the main phase. Further, from the results of Table 2, it was confirmed that the LiMnTi-containing oxide powder of Examples 1 to 6 had a smaller average particle diameter, a smaller crystal constant of a-axis, a fine and crystalline rock salt structure as the main phase, and a high discharge capacity compared to the LiMnTi-containing oxide powder of Comparative Examples 1 to 6.

What is claimed is:

1. A positive electrode active material for a lithium-ion secondary battery, comprising an oxide containing lithium, manganese, and titanium, wherein:
when a total content ratio of lithium, manganese, and titanium is set to 100 mol %,
a content ratio of lithium is in the range of 51 to 56 mol %,
a content ratio of manganese is in the range of 22 to 39 mol %, and
a content ratio of titanium is in the range of 10 to 23 mol %;
a content ratio of sodium is 0.12 mol % or less;
the oxide has a rock salt type structure; and
an average particle diameter of the oxide is in the range of 0.55 μm or more and 1.65 μm or less.

2. The positive electrode active material for a lithium-ion secondary battery according to claim 1, wherein a lattice constant of an a-axis is in the range of 4.1030 Å or more and 4.1210 Å or less.

3. The positive electrode active material for a lithium-ion secondary battery according to claim 1, wherein, in an X-ray diffraction pattern measured using CuKα as an X-ray source, a diffraction peak present in a diffraction angle 20 range of 43 degrees or more and 45 degrees or less has a full width at half maximum in a range of 0.360 degrees or more and 0.530 degrees or less.

4. The positive electrode active material for a lithium-ion secondary battery according to claim 1, wherein the content ratio of titanium is in the range of 15 mol % to 20 mol %.

5. A method for manufacturing a positive electrode active material for a lithium-ion secondary battery, the method comprising a step of performing a hydrothermal treatment on a NaMnTi-containing oxide in a lithium aqueous solution, wherein the NaMnTi-containing oxide contains sodium, manganese, and titanium, has a tunnel type structure, and has an average particle diameter in the range of 0.50 μm or more and 3.00 μm or less.

6. The method for manufacturing the positive electrode active material for a lithium-ion secondary battery according to claim 5, wherein in an X-ray diffraction pattern measured using CuKα as an X-ray source, the NaMnTi-containing oxide has a diffraction peak with a full width at half maximum in a range of 0.110 degrees or more and 0.190 degrees or less, in a diffraction angle 20 range of 62 degrees or more and 63 degrees or less.

7. A lithium-ion secondary battery comprising a positive electrode material mixture layer including the positive electrode active material for a lithium-ion secondary battery according to claim 1.
